(19) United States
(12) Patent Application Publication
(10) Pub. No.: US 2012/0146959 A1
(43) Pub. Date: Jun. 14, 2012

(54) ELECTRONIC READING DEVICE

(75) Inventor: PING-YANG CHUANG, Tu-Cheng (TW)

(73) Assignee: HON HAI PRECISION INDUSTRY CO., LTD., Tu-Cheng (TW)

(21) Appl. No.: 13/071,455

(22) Filed: Mar. 24, 2011

(30) Foreign Application Priority Data
Dec. 13, 2010 (TW) 99143475

(51) Int. Cl. G06F 3/033

(52) U.S. Cl. 345/179

(57) ABSTRACT

An electronic reading device is disclosed, for use with a handwriting pen that has a first working mode and a second working mode. The electronic reading device includes a display, a processor, a first controller, and a second controller. The first controller signals the processor and the second controller. The processor displays a track of the handwriting pen after being signaled by the first controller. The second controller sends a request to the handwriting pen to determine a working mode of the handwriting pen, and signals the processor when determining that the working mode is the second mode. The processor also erases the track after being signaled by the second controller.

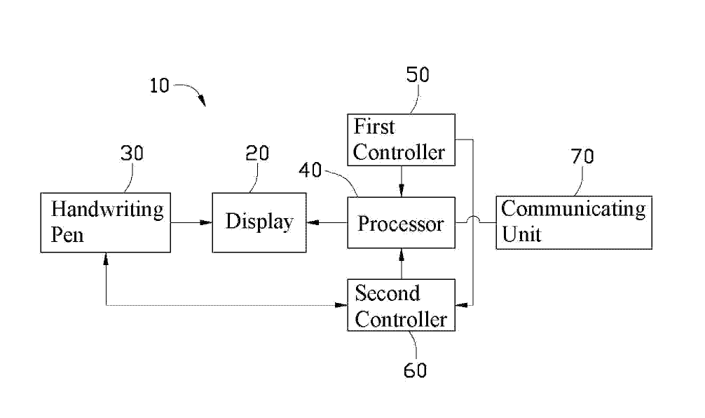

### BACKGROUND

1. Technical Field

The present disclosure relates to electronic reading devices, particularly, to an electronic reading device for use with a handwriting pen having a handwriting mode and a mouse mode.

2. Description of Related Arts

Electronic reading devices such as electrophoretic type electronic books have become popular. It is useful that an electronic reading device can be used with a handwriting pen, especially a handwriting pen having a handwriting mode and a mouse mode.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

The drawing is a block diagram of an electronic reading device according to one embodiment.

### DETAILED DESCRIPTION

Embodiments of the present disclosure will now be described in detail below, with reference to the accompanying drawings.

Referring to the drawing, an electronic reading device 10 includes a display 20. The display 20 is an electrophoretic type display, such as micro capsule type or Microcup type display. The display 20 includes a conventional touch panel that allows the display 20 to be used with a handwriting pen 30 having a handwriting mode and a mouse mode. In the handwriting mode, the handwriting pen 30 functions as a conventional handwriting pen. In the mouse mode, the handwriting pen 30 can move a cursor on the display 20.

The electronic reading device 10 can communicate with the handwriting pen 30 through a wireless communication unit 70, such as a WI-FI module or a BLUETOOTH module. The handwriting pen 30 stores an identification code that changes between a first value and a second value. The electronic reading device 10, through the wireless communication unit 70, can retrieve the identification code. The electronic reading device 10 determines a working mode of the handwriting pen 30 based on the retrieved identification code.

The electronic reading device 10 includes a processor 40, a first controller 50, and a second controller 60. When the handwriting pen 30 moves on the display 20, the first controller 50 signals the processor 40 and the first controller 50. The processor 40 then displays a track of the handwriting pen 30 on the display 20. At the same time, the second controller 60 sends a request to the handwriting pen 30. The handwriting pen 30 then transmits the identification code to the electronic reading device 10 in response to the request. The second controller 60 then determines the working mode of the handwriting pen 30.

Once determining that the handwriting pen 30 is in the mouse mode, the second controller 60 signals the processor 40. The processor 40 then erases the previously displayed track on the display 20 and generates a cursor that follows the tip of the handwriting pen 30.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. An electronic reading device for use with a handwriting pen having a first working mode and a second working mode, the electronic reading device comprising:
a display;
a processor;
a first controller; and
a second controller;
wherein the first controller is capable of signaling the processor and the second controller, the processor is capable of displaying a track of the handwriting pen after being signaled by the first controller, the second controller is capable of sending a request to the handwriting pen to determine a working mode of the handwriting pen, and signaling the processor when determining that the working mode is the second mode, the processor is further capable of erasing the track after being signaled by the second controller.

2. The electronic reading device according to claim 1, further comprising a communicating unit for wirelessly communicating with the handwriting pen.

3. The electronic reading device according to claim 1, wherein the display is a micro capsule type display.

4. The electronic reading device according to claim 1, wherein the display is a micro cup type display.

5. The electronic reading device according to claim 2, wherein the communicating unit is a WI-FI module or a BLUETOOTH module.

6. The electronic reading device according to claim 1, wherein the handwriting pen stores an identification code capable of changing between a first value and a second value, the second controller determines the working mode based on the identification code.
